(19) United States
(12) Patent Application Publication
(10) Pub. No.: US 2009/0251466 A1
(43) Pub. Date: Oct. 8, 2009

(54) Methods and Apparatus for Displaying Three-Dimensional Images for Analysis

(76) Inventor: James W. Cooper, Wilton, CT (US)

Correspondence Address: RYAN, MASON & LEWIS, LLP, 90 FOREST AVENUE, LOCUST VALLEY, NY, 11560, US

(21) Appl. No.: 12/098,707

(22) Filed: Apr. 7, 2008

(51) Int. Cl. G06T 15/10

(52) U.S. Cl. 345/427

(57) ABSTRACT

Techniques for presenting at least one 3D image to at least one user through a communications network are provided. A 3D image is obtained. The 3D image is converted into two or more 2D images. The two or more 2D images are stored in a data repository. At least a portion of the two or more stored 2D images is presented to the at least one user. The portion of the two or more stored 2D images is accessible by the at least one user via a browser program.

### FIELD OF THE INVENTION

The present invention relates to displaying images on a web browser and, more particularly, to techniques for processing and presenting three-dimensional (3D) images as multiple two-dimensional (2D) images.

### BACKGROUND OF THE INVENTION

Three-dimensional images are commonly used in medical imaging, such as computed tomography (CAT) and magnetic resonance imaging (MRI). They are also used in visual representations of structures and geologic activities. 3D images are large arrays of integers (or bytes) that contain layer-by-layer representations of each slice of the image. When 3D images are presented to users, the 3D images must be processed before they can be viewed. Typically, a robust application is needed to display and scroll through the layers of a 3D image. For example, in the case of medical images, a 3D image is displayed as a series of 2D slices. The 2D slices are cross-sections of the 3D image taken at successive intervals of 3D depth. The successive 2D slices are then stored in a large data file, which can only be accessed by the robust application used to create the 2D slices.

Conventional techniques of 3D image processing suffer practical issues that remain unsolved. First, conventional techniques require the utilization of bulky stand-alone software. For instance, researchers and clinicians who wish to manage and examine 3D images, such as CAT scans and MRIs, are required to install and use resource intensive 3D imaging software. This raises an issue of compatibility because certain image formats (e.g., Digital Imaging and Communications in Medicine (DICOM), ANALYZE) may require special proprietary or public domain software for viewing. Therefore, a user must typically load multiple image programs on his or her individual workstation in order to view and study images of various formats.

The installation of imaging software also raises the issue of portability. Conventional techniques do not give researchers and clinicians quick access to 3D images because format-specific imaging software must be installed on an access terminal prior to viewing. This can be an issue in the medical field especially when a clinician requires immediate and remote access to medical images of a patient in order to make an emergency diagnosis. Currently, there are no techniques that allow users to access 3D images using ordinary and universal interfaces such as web browsers (e.g., Internet Explorer® (a registered trademark of Microsoft Corporation) and Mozilla FireFox® (a registered trademark of Mozilla Foundation)).

### SUMMARY OF THE INVENTION

An illustrative embodiment of the present invention meets the above-noted needs by providing techniques for presenting 3D images to users through a communications network. These techniques offer several advantages over conventional methodologies, including: (i) allowing users to access complex images without using bulky stand-alone software; (ii) overcoming image format and software compatibility issues; and (ii) faster and more efficient presentation of 3D images via a web browser.

In a first aspect of the present invention, a method for presenting at least one 3D image to at least one user through a communications network is presented. A 3D image is obtained. The 3D image is converted into two or more two-dimensional (2D) images. The two or more 2D images are stored in a data repository. At least a portion of the two or more stored 2D images is presented to the at least one user. The portion of the two or more stored 2D images is accessible by the at least one user via a browser program.

The 3D image may be in a Digital Imaging and Communications in Medicine (DICOM) data format and/or ANALYZE data format. Further, each of the two or more 2D images may be a slice of the 3D image. In an additional embodiment, the two or more 2D images may be in a compressed format. The compressed format may be a Joint Photographic Experts Group (JPEG) format.

In an additional embodiment of the present invention, the step of storing may further comprise the steps of creating at least one directory in the data repository, and storing the two or more 2D images in the at least one directory. The at least one directory may be deleted in accordance with an idle time. Further, it may be determined if two or more stored 2D images exist for the 3D image. Also, the portion of the two or more stored 2D images may be associated with a medical report.

In an alternative embodiment of the invention, the browser program may be operative to display the portion of the two or more stored 2D images. Also, the browser program may be operative to cache the portion of the two or more stored 2D images. Further, the browser program may be operative to scroll through the two or more stored 2D images and the scrolling may be in accordance with a scrollbar and/or a time delay.

In a second aspect of the present invention, an article of manufacture for presenting at least one 3D image to at least one user via a communications network comprises a computer readable storage medium identified by one or more programs, which when executed by a computer implement the above steps.

In a third aspect of the invention, an apparatus for presenting at least one 3D image to at least one user through a communications network comprises a memory and at least one processor coupled to the memory and operative to: (i) obtain a 3D image; (ii) convert the 3D image into two or more 2D images; (iii) store the two or more 2D images in a data repository; and (iv) present at least a portion of the two or more stored 2D images to the at least one user. The portion of the two or more stored 2D images is accessible by the at least one user via a browser program.

In accordance with a fourth aspect of the present invention, a web-based system for presenting at least one 3D image to at least one user through a communications network is provided. The system comprises a client device and at least one server coupled to the client device. The at least one server is operative to: (i) obtain a 3D image; (ii) convert the 3D image into two or more 2D images; and (iii) store the two or more 2D images in a data repository. The client device is operative to: (i) request at least a portion of the two or more stored 2D images from the at least one server; and (ii) access the portion of the two or more stored 2D images via a browser program.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating a methodology for presenting at least one 3D image to at least one user through a communications network, according to an embodiment of the present invention.

FIG. 2 is a diagram illustrating a system for presenting at least one 3D image to at least one user through a communications network, in accordance with an embodiment of the present invention.

FIG. 3 is a diagram illustrating an exemplary user interface for selecting image records of patients, in accordance with an embodiment of the present invention.

FIG. 4 is an exemplary table used for image management, in accordance with an embodiment of the present invention.

FIG. 5 is a diagram illustrating an exemplary image display and a scroll mechanism, in accordance with an embodiment of the present invention.

FIG. 6 is a diagram illustrating an exemplary display showing two 2D images, wherein the 2D images may be controlled using a scroll mechanism or an image number field, in accordance with an embodiment of the present invention.

FIG. 7 is a diagram illustrating an illustrative hardware implementation of a computing system in accordance with which one or more components/methodologies of the present invention may be implemented, according to an embodiment of the present invention.

### DETAILED DESCRIPTION OF PREFERRED EMBODIMENTS

The present invention will be described in conjunction with exemplary methods for presenting at least one 3D image to at least one user through a communications network. It should be understood, however, that the invention is not limited to the particular embodiments described herein. The principles of this invention are generally applicable to any technique used for managing and accessing images using the web, and modifications to the illustrative embodiments will become apparent to those skilled in the art given the teachings described herein.

The term “browser program” as used herein is intended to be construed broadly so as to encompass, by way of example and without limitation, any computer-based application used to locate and display web pages.

The term “data repository” as used herein is intended to be construed broadly so as to encompass, by way of example and without limitation, a computer-based device used for storing data.

The term “directory” as used herein is intended to be construed broadly so as to encompass, by way of example and without limitation, an organizational unit used to organize data files into a hierarchical structure.

Referring initially to FIG. 1, a flow diagram illustrates a methodology for presenting at least one 3D image to at least one user through a communications network, according to an embodiment of the present invention. In an illustrative embodiment, methodology 100 may be carried out by one or more image processing servers in combination with one or more web servers (e.g., IBM Websphere®, IBM Apache HTTP®). In an alternative embodiment, the processes of an image processing server and a web server may be combined into one server.

Methodology 100 begins at step 102 where a 3D image is obtained by an image processing server. In an exemplary embodiment, a 3D image is obtained from a 3D image database. The database may comprise patient medical records (e.g., CAT scans, MRIs) in a specific data format (e.g., Digital Imaging and Communications in Medicine (DICOM), ANALYZE) or the database may comprise a collection of geographic imaging data. At step 104, the 3D image is converted into two or more 2D images. For example, a 3D MRI may be converted into a collection of 2D slices. At step 106, the two or more 2D images are stored in one or more data repositories (e.g., 2D image database). In one embodiment, the data repository is maintained within a web server allowing for quick accessibility to the images via a web page.

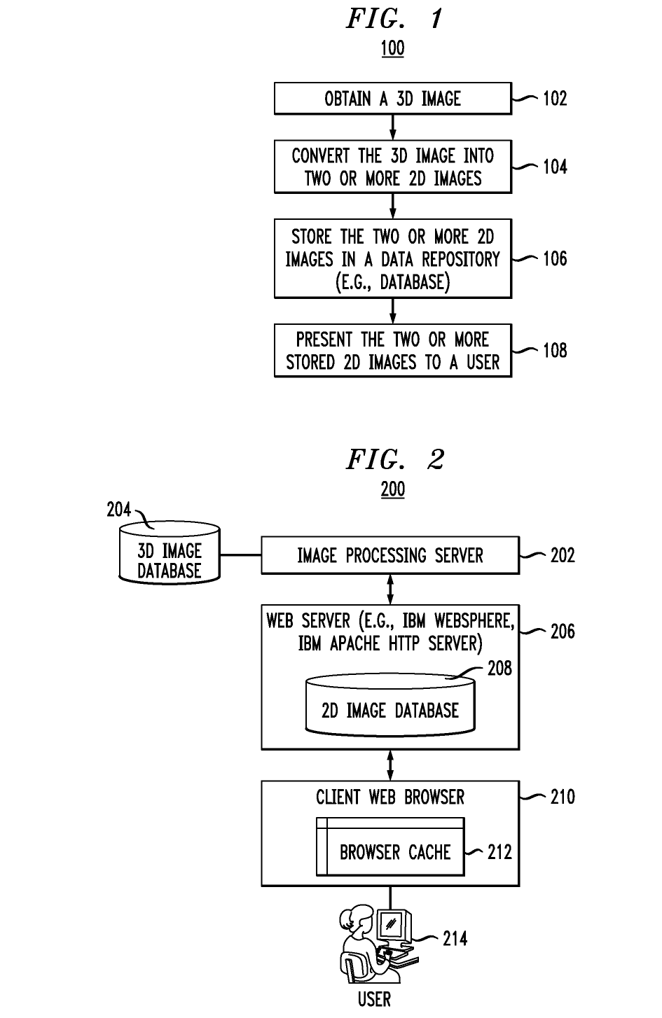

The stored images are then presented upon a user request. In an exemplary embodiment, a user accesses the two or more stored 2D images via a client web browser. By doing so, a user is not required to pre-install imaging software onto his or her workstation terminal in order to view the stored images. A more detailed description of how the 2D images are managed and presented is disclosed below with reference to FIG. 2.

Referring now to FIG. 2, a diagram illustrates a system for presenting at least one 3D image to at least one user through a communications network, in accordance with an embodiment of the present invention. In an exemplary embodiment, system 200 carries out the methodology of FIG. 1. Image processing server 202 carries out steps 102 to 106 of methodology 100. The image processing server 200 is coupled to a 3D image database 204. When a user 214, via a client web browser 210, makes a request to view a 3D image, the 3D image database 204 supplies the requested 3D image to the image processing server 202. The 3D image is then converted (e.g., expanded) into multiple 2D images. In an illustrative embodiment, each 2D image is in a compressed format, such as Joint Photographic Experts Group (JPEG) format, which can be readily displayed on a web browser without additional intervening software.

The image processing server 202 then stores the 2D images at a 2D image database 208. In an exemplary embodiment, the 2D image database 208 is maintained by a web server 206. The web server 206 is preferably an IBM Webspher® or an IBM Apache HTTP® server.

In an exemplary embodiment, the 2D images are stored in a newly created directory on the 2D image database 208. Further, a uniform resource locator (URL) referring to the directory is communicated to the web server 206. The URL may be used as a link on a web page, giving a user direct access to the stored 2D images. In an illustrative embodiment, the 2D images are maintained in the 2D image database 208 as long as users continue to access the files. In order to track and maintain the 2D images, log information is recorded in a log table or database located at the web server 206. The log table may comprise the name of the expanded 3D image, location of the corresponding 2D images, the date and time of when the 3D image was expanded, and the date and time of when the 2D images were last accessed.

In one embodiment, the image processing server 202 may refer to the log table to prevent repeated conversion of 3D images which have already been expanded. Furthermore, the web server 206 may refer to the log table for periodic housekeeping purposes. In one example, 2D images that are not accessed within a pre-determined period of time (e.g., idle images) may be expunged for space efficiency. In an exemplary embodiment, the expunged 2D images are removed from the log table. This allows the image processing server 202 to recreate the expunged 2D images at a future date.

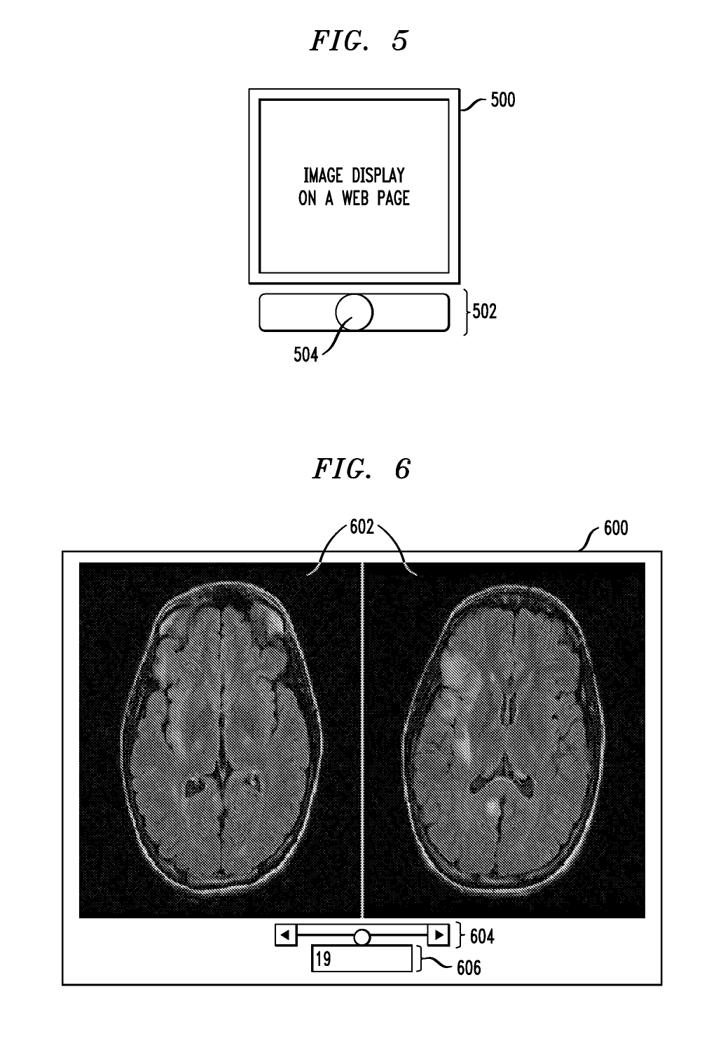

After a requested 3D image is converted and its 2D images are stored, a user 214, using a client web browser 210, may access the expanded 2D images stored in the 2D image database 208. In an exemplary embodiment, the web server 206 directs the client web browser 210 to a web page that contains browser scripting code in a language such as JavaScript. The scripting code instructs the client web browser 210 to read and load the 2D images into its browser cache 212. After the initial load, the user 214 can quickly scroll through the images successively with minimal processing delays. In an additional embodiment, the scripting code may incorporate a scrollbar or other mechanism to control how the successive images are displayed. Presentation of the images will be discussed below with reference to FIGS. 5 and 6. It is to be appreciated that the client web browser 210 may be on a personal computer, workstation, or other web connected device, such as a cell phone. This arrangement gives the user 214 the freedom to view images at his or her convenience and without the need for pre-loaded imaging software.

Referring now to FIG. 3, a diagram illustrates an exemplary user interface for selecting image records of patients, in accordance with an embodiment of the present invention. In this exemplary embodiment, a user (e.g., clinician) may request MRI images for patients according to name 302, sex 304, age 306, and/or MRI image type 308. The user submits the request by clicking on the “View patient” button 310. This sends the request to the web server 206, which in turn, orders the image processing server 202 to locate, retrieve, and convert the requested 3D image file. The 3D image file is read slice by slice and each slice is converted into a compressed 2D image which can be displayed on the client web browser 210. The set of 2D slices is stored as a set of files in a directory on the 2D image database 208.

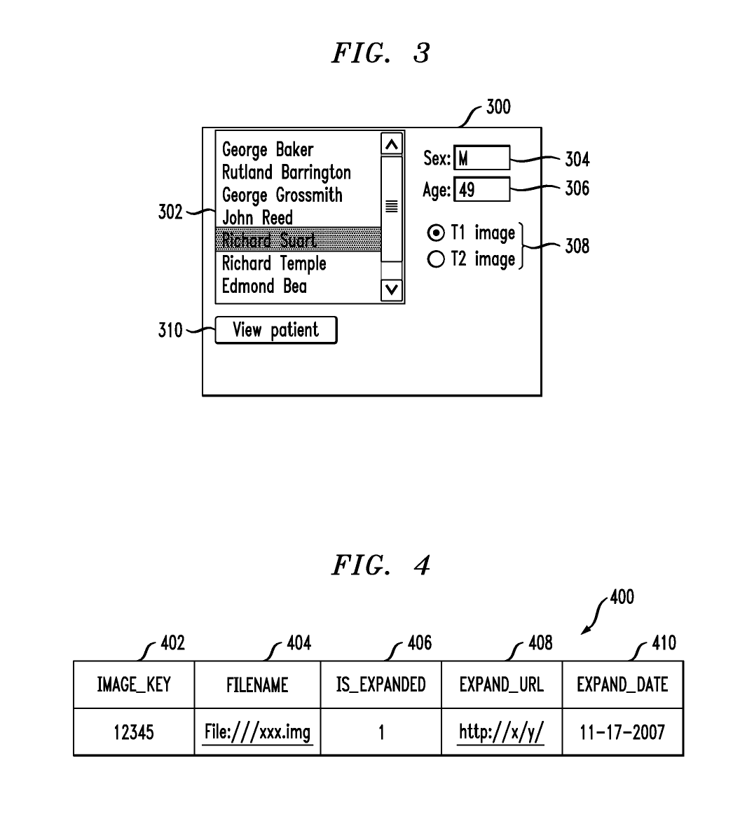

Referring now to FIG. 4, a diagram illustrates an exemplary table used for image management, in accordance with an embodiment of the present invention. The event of expanding a 3D image is recorded on a log table 400 located on the web server 206. In an exemplary embodiment, each log entry comprises an automatically assigned image key number 402, the location of the stored 2D images 404, a field indicating if the 3D image has been expanded 406 (e.g., ‘0’ for no and ‘1’ for yes), the URL of the expanded images 408, and the date the 3D image was expanded 410.

In a preferred embodiment, additional information may be intertwined with the image data. For example, in the medical field, a medical report may be associated with the images of a patient, or vice versa. Each medical report may be mined for patient names and relationships and additional reports, such as previous diagnoses, drugs, dosages, and other images including X-ray images, may be cross-referenced and retrieved. Cross-referenced terms and reports may be stored in a database maintained by or coupled to the web server 206. In an illustrative embodiment, a cross-referencing term may be highlighted and linked to a corresponding document in the database. Further, medical information may be displayed in a pop-up window when the user points a mouse cursor on a highlighted term.

Referring now to FIG. 5, a diagram illustrates an exemplary image display and a scroll mechanism, in accordance with an embodiment of the present invention. Image display 500 displays one or more images. The web page that displays the first image may also display a scroll mechanism 502 with a slide button 504. In a preferred embodiment, the web page is written in JavaScript and a user may move the slide button 504 from side to side to scroll through the images. The scripting code of the web page receives notice of this motion, and displays the next successive image. This gives the effect of scrolling through the images smoothly as if the user were scrolling through a 3D image. It is to be noted that multiple images may be displayed on display 500 at one time and the images may be controlled by one or more scrolling mechanisms 502. The number of images or sets of images that can be displayed at a single time is limited only by available screen space. For example, two, three, or six images may be displayed at once and scrolled through in real time.

Referring now to FIG. 6, a diagram illustrates an exemplary display showing two 2D images, wherein the 2D images may be controlled using a scroll mechanism or an image number field, in accordance with an embodiment of the present invention. In this example, a display 600 shows two 2D slices 602 of a 3D MRI image. By utilizing the scroll mechanism 604, a user may scroll through the 2D slices. A user may also navigate through the images by specifying the slide number of an image slice in the image number field 606. In another preferred implementation, the scrolling between images is accomplished by a simple time delay between the loading and display of successive images, giving the effect of a movie. The time delay may be user-defined or pre-programmed into the script of the web page.

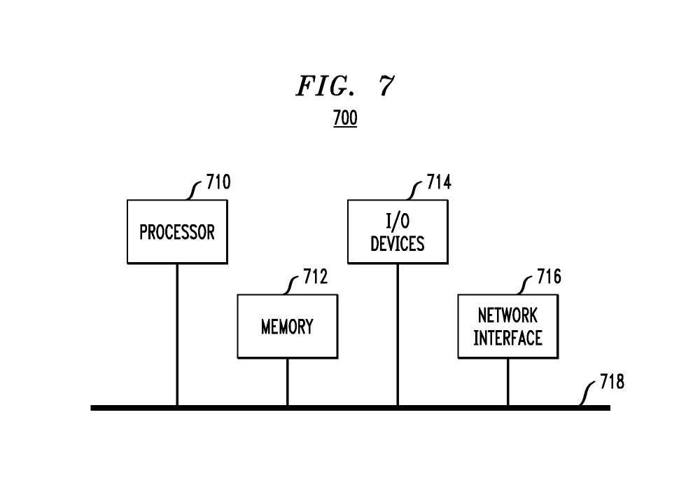

Referring now to FIG. 7, step diagram 700 illustrates an exemplary hardware implementation of a computing system in accordance with which one or more components/methodologies of the invention (e.g., components/methodologies described in the context of FIGS. 1-6) may be implemented, according to an embodiment of the present invention.

As shown, the techniques for presenting at least one 3D image to at least one user through a communications network may be implemented in accordance with a processor 710, a memory 712, I/O devices 714, and a network interface 716, coupled via a computer bus 718 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory “as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Still further, the phrase “network interface” as used herein is intended to include, for example, one or more transceivers to permit the computer system to communicate with another computer system via an appropriate communications protocol.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method for presenting at least one three-dimensional (3D) image to at least one user through a communications network, the method comprising:
obtaining a 3D image;
converting the 3D image into two or more two-dimensional (2D) images;
storing the two or more 2D images in a data repository; and
presenting at least a portion of the two or more stored 2D images to the at least one user, wherein the portion of the two or more stored 2D images is accessible by the at least one user via a browser program.

2. The method of claim 1, wherein the 3D image is in at least one of a Digital Imaging and Communications in Medicine (DICOM) data format and ANALYZE data format.

3. The method of claim 1, wherein each of the two or more 2D images is a slice of the 3D image.

4. The method of claim 3, wherein the two or more 2D images are in a compressed format.

5. The methods of claim 4, wherein the compressed format is a Joint Photographic Experts Group (JPEG) format.

6. The method of claim 1, wherein the step of storing further comprises the steps of:
creating at least one directory in the data repository; and
storing the two or more 2D images in the at least one directory.

7. The method of claim 6, further comprising the step of deleting the at least one directory in accordance with an idle time.

8. The method of claim 1, wherein the browser program is operative to display the portion of the two or more stored 2D images.

9. The method of claim 1, wherein the browser program is operative to cache the portion of the two or more stored 2D images.

10. The method of claim 1, wherein the browser program is operative to scroll through the two or more stored 2D images, wherein the scrolling is in accordance with at least one of a scrollbar and a time delay.

11. The method of claim 1, further comprising the step of determining if two or more stored 2D images exist for the 3D image.

12. The method of claim 1, wherein the portion of the two or more stored 2D images is associated with a medical report.

13. An article of manufacture for presenting at least one 3D image to at least one user via a communications network, the article comprising a computer readable storage medium identified by one or more programs, which when executed by a computer implement the steps of claim 1.

14. An apparatus for presenting at least one three-dimensional (3D) image to at least one user through a communications network, the apparatus comprising:
a memory; and
at least one processor coupled to the memory and operative to: (i) obtain a 3D image; (ii) convert the 3D image into two or more two-dimensional (2D) images; (iii) store the two or more 2D images in a data repository; and (iv) present at least a portion of the two or more stored 2D images to the at least one user, wherein the portion of the two or more stored 2D images is accessible by the at least one user via a browser program.

15. The apparatus of claim 14, wherein each of the two or more 2D images is a slice of the 3D image.

16. The apparatus of claim 14, wherein the at least one processor is further operative to: (i) create at least one directory in the data repository; and (ii) store the two or more 2D images in the at least one directory.

17. The apparatus of claim 16, wherein the at least one processor is further operative to delete the at least one directory in accordance with an idle time.

18. The apparatus of claim 14, wherein the browser program is operative to scroll through the two or more stored 2D images, wherein the scrolling is in accordance with at least one of a scrollbar and a time delay.

19. The apparatus of claim 14, wherein the portion of the two or more stored 2D images is associated with a medical report.

20. A web-based system for presenting at least one three-dimensional (3D) image to at least one user through a communications network, the system comprising:
a client device; and
at least one server coupled to the client device;
wherein the at least one server is operative to: (i) obtain a 3D image; (ii) convert the 3D image into two or more two-dimensional (2D) images; and (iii) store the two or more 2D images in a data repository,
wherein the client device is operative to: (i) request at least a portion of the two or more stored 2D images from the at least one server; and (ii) access the portion of the two or more stored 2D images via a browser program.
